(19) United States
(12) Patent Application Publication
(10) Pub. No.: US 2021/0116902 A1
(43) Pub. Date: Apr. 22, 2021

(54) SENSOR MEASUREMENT SYNCHRONICITY

(71) Applicant: AKTIEBOLAGET SKF, Goteborg (SE)

(72) Inventors: Jens GRAF, Schweinfurt (DE); Mikael Ronnkvist, Luleå (SE); Fredrik Sundquist, Luleå (SE)

(21) Appl. No.: 16/658,379

(22) Filed: Oct. 21, 2019

(51) Int. Cl. G05B 23/02; G05B 15/00

(52) U.S. Cl. CPC G05B 23/0208; G05B 15/00; G05B 23/0267

(57) ABSTRACT

A system for synchronous control of a plurality of sensors for sensing at least one characteristic such as temperature, vibration or movement, of at least one bearing, is provided. The system includes the plurality of sensors, which are in association with at least one machine. The system also includes a management device communicatively coupled to the plurality of sensors. The system provides, to the plurality of sensors, a measurement command to instruct the plurality of sensors to perform synchronous measurements of the at least one machine. The system receives, from the plurality of sensors, a plurality of measurement values corresponding to the synchronous measurements.

### BACKGROUND

Current condition monitoring solutions measure rotating equipment. However, measurements by current condition monitoring solutions are performed manually and are quite time consuming. In fact, a technician needs to position a sensor on the rotating equipment to monitor and trigger measurements, along with repeating this positioning regularly, to detect an early failure as soon as possible. If a facility has several hundreds or thousands of positions to measure, the technician's task becomes extremely time consuming and includes inherent errors. Moreover, because all manual measurements are performed one by one, any cross analysis can be difficult and/or slow to execute.

Further, while in current condition monitoring solutions cases multiple machines can be monitored at the same time, data resulting from this monitoring is not in a time wave form and is generally just an average measurement across the multiple machines (e.g., a maximum acceleration of the rotation equipment). It is not possible to do any additional processing on this data, such as Fast Fourier Transforms.

### SUMMARY

In accordance with one or more embodiments, a system for synchronous control of a plurality of sensors is provided. The function of the sensors is to sense at least one characteristic such as temperature, vibration or movement, of at least one bearing. The system includes the plurality of sensors, which are in association with at least one machine. The system also includes a management device communicatively coupled to the plurality of sensors. The system provides, to the plurality of sensors, a measurement command to instruct the plurality of sensors to perform synchronous measurements of the at least one machine. The system receives, from the plurality of sensors, a plurality of measurement values corresponding to the synchronous measurements.

In accordance with one or more embodiments or any of the system embodiments above, the plurality of sensors can include a common time.

In accordance with one or more embodiments or any of the system embodiments above, the measurement command can include a time for when to perform the synchronous measurements.

In accordance with one or more embodiments or any of the system embodiments above, the plurality of sensors trigger their respective measurements at the time indicated by the measurement command to perform synchronous measurements across the system.

In accordance with one or more embodiments or any of the system embodiments above, the measurement command can be sent to a sensor group of the plurality of sensors, each sensor of the sensor group being at a different position on a machine of the at least one machine.

In accordance with one or more embodiments or any of the system embodiments above, each sensor of the plurality of sensors can locally save a corresponding measurement value of the plurality of measurement values for access by the system.

In accordance with one or more embodiments or any of the system embodiments above, the system can provide an acquire command to the plurality of sensors to instruct the plurality of sensors to send the plurality of measurement values to the management device.

In accordance with one or more embodiments or any of the system embodiments above, the receiving of the plurality of measurement values can be based on an automatic measurement forwarding.

In accordance with one or more embodiments or any of the system embodiments above, the system can execute a machine evaluation utilizing the plurality of measurement values received from the plurality of sensors to determine if an event occurred within the plurality of measurement values.

In accordance with one or more embodiments or any of the system embodiments above, the system can include a network supporting communication between the management device and the plurality of sensors.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter described herein is particularly pointed out and distinctly claimed in the claims at the conclusion of the specification. The foregoing and other features, and advantages of the embodiments herein are apparent from the following detailed description taken in conjunction with the accompanying drawings in which:

FIG. 1 is a system according to an embodiment;

FIG. 2 is a flow diagram according to an embodiment; and

FIG. 3 is management device according to one or more embodiments.

### DETAILED DESCRIPTION

Embodiments described herein relate to system including sensors that are managed by a management device. The management device automates measurements by the sensors so that measurements can be taken in greater volume, at higher frequency, and with greater accuracy. Further, the management device can further synchronize measurements by the sensors on a single machine or across an entire production channel.

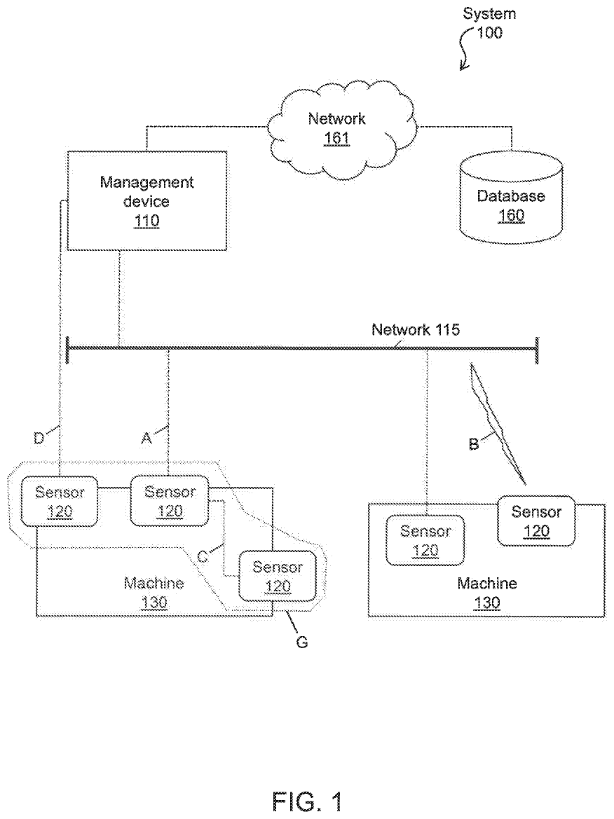

Turning now to FIG. 1, a system 100 is generally shown in accordance with an embodiment. The system 100 is managed by a management device 110. The management device 110 communicates through a network 115 to one or more sensors 120 (herein interchangeably referred to in the singular and in the plural), each of which is associated with one or more machines 130. The management device 110 further communicates with a database 160, through the network 161 (e.g., Ethernet, cellular, etc.). In accordance with one or more embodiments the communication can be across a wired connection, as shown by dashed-line A, or a wireless connection, as shown by lighting bolt B. In some cases, any of the devices of the system 100 may be connected in parallel or may be serially connected, as shown by dashed-line C.

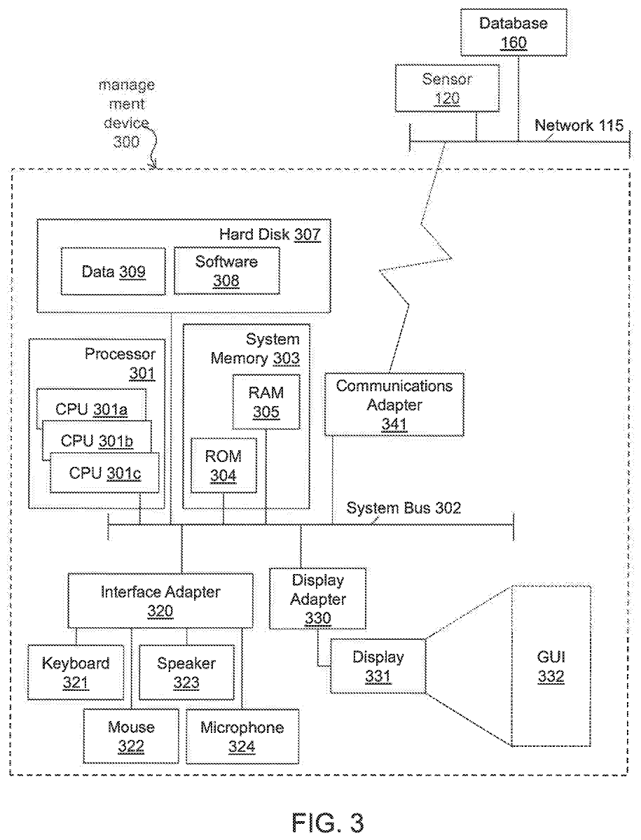

The management device 110, generally shown in accordance with an embodiment, can be an electronic, computer framework comprising and/or employing any number and combination of computing device and networks utilizing various communication technologies, as described herein. The management device 110 can be scalable, extensible, and modular, with the ability to change to different services or reconfigure some features independently of others. An example of the electronic components of the management device 110 is described with respect to FIG. 3.

The management device 110 can communicate commands and receive electrical signal to and from other devices of the system 100, whether through the network 115 or directly (as shown by dashed-line D). The management device 110 can, utilizing commands to exercise synchronous control, trigger measurements by all sensors 120 (connected thereto), a group G of sensors 120 linked to the machine 130, and/or any specific/individual sensor 120. In accordance with one or more embodiments, the management device 110 can trigger synchronous measurements. In this regard, the management device 110 can leverage a common time that is given to each sensor 120 (by that sensor's operating system, which may be developed by an external supplier).

The networks 115 and 161 can be any local area network, a wide area network, and/or a wireless network (e.g., an intranet or the Internet) that supports one or more devices, such as the management device 110 and the sensors 120. The networks 114 and 161 may comprise copper transmission cables, optical transmission fibers, wireless transmission, routers, firewalls, switches, management device computers and/or edge servers.

The sensor 120 can be any transducer for converting an environmental condition (e.g., vibration, temperature, movement, etc.) to an electrical signal. Movement means for instance a displacement, a speed or an acceleration. The sensors are for sensing at least one characteristic or such environmental condition of a bearing. The bearing can be with or without rolling elements such as balls or rollers. In general, the sensor 120 can include a housing, at least one sensing element (e.g., strain gauge, thermocouple, accelerometer, etc.), a data collector (e.g., a processor and a memory as described herein), data transmission electronics (e.g., a wireless modem and/or a near field communication (NFC) transponders), and an attachment component that affixes the sensor 120 to the machine. The attachment component can be any bracket, flange, or the like that attaches the sensor 120 to the machine 130 to be monitored. The sensors 120 can be distributed across the machine 130 to procure measurements at different locations (e.g., the sensors 120 can be positioned vertically or horizontally on a motor or a gearbox). In operation, in accordance with one or more embodiments, each sensor 120 maintains the common time, which may be given to each sensor 120 by that sensor's operating system. Further, each sensor 120 operates with respect to a timing requirement for communication. For example, the timing requirement may include having to communicate each 10 ms, where a time reference (e.g., the common time) is assumed to be always the same.

The machine 130 can be any mechanical system or rotating equipment (e.g., a motor, a gearbox, an electric motor, an axel box, a generator, etc.) that can be monitored for the environmental conditions.

The database 160 can be any computer or electronic device that stores and organizes data (e.g., sensor data) and data structures, examples of which include schemas, tables, queries, reports, views and other objects.

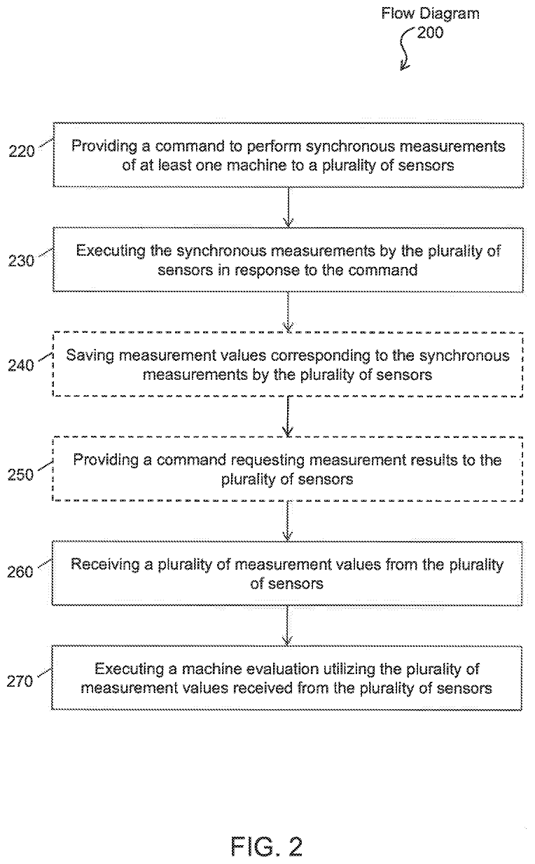

Turning now to FIG. 2, a flow diagram 200 is generally shown in accordance with an embodiment. The flow diagram 200 depicts an example operation of the system 100. The flow diagram begins at block 220, where the system 100 provides a command or a measurement command. The measurement command can be an electrical signal instructing the sensors 120 to perform an action, such as synchronous measurements of the one or more machines 130. This measurement command can include a time (e.g., a first time value) for when to perform the action (e.g., every minute, every 30 minutes, every three hours, at a specified time, at a specified time each minute/hour/day/week, etc.). In this regard, the system 100 can leverage the common time that is given to each sensor 120. In accordance with one or more embodiments, the management device 110 sends the measurement command over the network 115 to the sensors 120.

The measurement command can be sent across the network 115, directly, and/or indirectly, whether wirelessly or wired. The measurement command can be send an individual sensor 120, to a sensor group 120 (as shown by group G), to sensors 120 on the same machine 130, to sensors 120 at the same position but on different machines 130, etc. In accordance with one or more embodiment, the measurement command can also include a time (e.g., a second time value) for when the sensors 120 should send with any measurement value corresponding to the synchronous measurements to the system 100 and/or the management device 110 (e.g., so that automatic measurement forwarding is enabled). Automatic measurement forwarding includes when the sensors 120 send to the system 100 and/or the management device 110 their respective measurement values without receiving a specific request from the management device 110.

At block 230, each sensor 120 executes the action (e.g., synchronous measurements) in response to the command. If the command includes a time, then the sensors 120 execute the action according to that time. In this regard, the sensors 120 trigger their respective measurements at the same moment to perform synchronous measurements across the system 100.

At dashed-block 240, each sensor 120 saves a measurement value corresponding to the synchronous measurements. A measurement value is representative of one or more values, such as a measurements series of vibration data, e.g., with a fixed sample rate over a configured time duration and/or a vibration measurement, time wavefrom. Each measurement value can be saved/accumulated within the data collector of the sensor 120 for access by the management device 110. Each measurement value can be saved/accumulated with respect to the common time at the instance that measurement was taken. Note that dashed-block 240 is optional.

At dashed-block 250, the system 100 (e.g., the management device 110) provides a command or an acquire command to the sensors 120. The acquire command can be an electrical signal instructing the sensors 120 to send at least one measurement value to the management device 110. This acquire command can include a time (e.g., a third time value) for when to send the at least one measurement value (e.g., every minute, every 30 minutes, every three hours, at a specified time, at a specified time each minute/hour/day/week, etc.). This acquire command can include a time and/or a time range (e.g., a fourth time value) specifying which of the at least one measurement values are desired. In accordance with one or more embodiments, the acquire command can instruct the sensors 120 to send a single measurement, multiple measurements within a time range, measurement values at distinct time instances, all saved/accumulated measurement values, and the like to the management device 110. In this regard, the management device 110 can again leverage the common time that is given to each sensor 120. The acquire command can be sent across the network 115, directly, and/or indirectly, whether wirelessly or wired. Note that dashed-block 250 is optional. Note also that the acquire command can trigger the automatic measurement forwarding.

At block 260, the system 100 (e.g., the management device 110) receives a plurality of measurement values from the sensors 120. In accordance with one or more embodiments, the management device 110 may receive the measurement values based on the automatic measurement forwarding. Further, the plurality of measurement values can be received by the system 100 (e.g., the management device 110) in response to the acquire command.

At block 270, the system 100 (e.g., the management device 110) executes a machine evaluation utilizing the plurality of measurement values (e.g., data) received from the sensors 120. Machine evaluation includes determining if an event occurred within the plurality of measurement values (e.g., with respect to one measurement value by not in a second measurement value), which can be used to understand how vibration are transmitted in the machine 130. In accordance with one or more embodiments, once the management device 110 has the data, the data can processed, evaluated, and checked for any abnormal vibrations or failures (e.g., from a supervision room and a computer connected to the management device 100). The machine evaluation can be performed at the management device 100 (or on a backend server or cloud), therefore removing any need for a technician to walk thought a plant to manually retrieve the data, as in current condition monitoring solutions.

Technical effects and benefits of embodiments herein includes an ability by the system to execute and compare synchronous measurements performed on the same machine and/or at different locations. In this regard, because the synchronous measurements can be executed for and compared at different locations, the system can determine whether vibrations occurring in one direction could have some impact on another direction and/or whether vibrations at one end of a machine can be transmitted to another end (e.g., such as in a large rotating equipment).

Turning now to FIG. 3, a management device 110 for implementing the teachings herein is shown in according to one or more embodiments. In this embodiment, the management device 110 has a processor 301, which can include one or more central processing units (CPUs) 301a, 301b, 301c, etc. The processor 301, also referred to as a processing circuit, microprocessor, computing unit, is coupled via a system bus 302 to a system memory 303 and various other components. The system memory 303 includes read only memory (ROM) 304 and random access memory (RAM) 305. The ROM 304 is coupled to the system bus 302 and may include a basic input/output system (BIOS), which controls certain basic functions of the management device 110. The RAM is read-write memory coupled to the system bus 302 for use by the processor 301.

The management device 110 of FIG. 3 includes a hard disk 307 or other nonvolatile memory (e.g., Flash memory), which is an example of a tangible storage medium readable executable by the processor 301. The hard disk 307 stores software 308 and data 309. The software 308 is stored as instructions for execution on the management device 110 by the processor 301 (to perform processes, such as the process flows of FIG. 2 or the machine evaluation of sensor data). The data 309 includes a set of values of qualitative or quantitative variables organized in various data structures to support and be used by operations of the software 308 (e.g., sensor data).

The management device 110 of FIG. 3 includes one or more adapters (e.g., hard disk controllers, network adapters, graphics adapters, etc.) that interconnect and support communications between the processor 301, the system memory 303, the hard disk 307, and other components of the management device 110 (e.g., peripheral and external devices). In one or more embodiments of the present invention, the one or more adapters can be connected to one or more I/O buses that are connected to the system bus 302 via an intermediate bus bridge, and the one or more I/O buses can utilize common protocols, such as the Peripheral Component Interconnect (PCI).

As shown, the management device 110 includes an interface adapter 320 interconnecting a keyboard 321, a mouse 322, a speaker 323, and a microphone 324 to the system bus 302 (optionally, the management device 110 may have no user interface and use Flash/RAM for storage). The management device 110 includes a display adapter 330 interconnecting the system bus 302 to a display 331. The display adapter 330 (and/or the processor 301) can include a graphics controller to provide graphics performance, such as a display and management of a GUI 332. A communications adapter 341 interconnects the system bus 302 with the network 115 enabling the management device 110 to communicate with other systems, devices, data, and software, such as the sensors 120 and the database 160. In one or more embodiments of the present invention, the operations of the software 308 and the data 309 can be implemented on the network 115 by the sensor 120 and the database 160. For instance, the network 115, the sensor 120, and the database 160 can combine to provide internal iterations of the software 308 and the data 309 as a platform as a service, a software as a service, and/or infrastructure as a service (e.g., as a web application in a distributed system).

Thus, as configured in FIG. 3, the operations of the software 308 and the data 309 (e.g., the management device 110) are necessarily rooted in the computational ability of the processor 301 and/or the server 351 to overcome and address the herein-described shortcomings of the current condition monitoring solutions. In this regard, the software 308 and the data 309 improve computational operations of the processor 301 and/or the server 351 of the management device 110 by reducing errors in measurements and increasing measurement efficiency.

Embodiments herein may be a system, a method, and/or a computer program product. The computer program product may include a computer readable storage medium (or media) having computer readable program instructions thereon for causing a processor to carry out aspects of the embodiments herein. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the embodiments herein.

Aspects of the embodiments herein are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions. In this way, the flowchart and block diagrams in the FIGS. illustrate the architecture, operability, and operation of possible implementations of systems, methods, and computer program products according to various embodiments. Further, each block in the flowchart or block diagrams may represent a module, segment, or portion of instructions, which comprises one or more executable instructions for implementing the specified logical operation(s). In some alternative implementations, the operations noted in the block may occur out of the order noted in the FIGS. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A system for synchronous control of a plurality of sensors for sensing at least one characteristic such as temperature, vibration or movement, of at least one bearing, the system comprising:
the plurality of sensors in association with at least one machine; and
a management device communicatively coupled to the plurality of sensors,
the system being configured to perform operations comprising:
providing, to the plurality of sensors, a measurement command to instruct the plurality of sensors to perform synchronous measurements of the at least one machine; and
receiving, from the plurality of sensors, a plurality of measurement values corresponding to the synchronous measurements.

2. The system of claim 1, wherein the plurality of sensors comprise a common time.

3. The system of claim 1, wherein the measurement command comprises a time for when to perform the synchronous measurements.

4. The system of claim 3, wherein the plurality of sensors trigger their respective measurements at the time indicated by the measurement command to perform synchronous measurements across the system.

5. The system of claim 1, wherein the measurement command is sent to a sensor group of the plurality of sensors, each sensor of the sensor group being at a different position on a machine of the at least one machine.

6. The system of claim 1, wherein each sensor of the plurality of sensors locally saves a corresponding measurement value of the plurality of measurement values for access by the system.

7. The system of claim 1, the system being configured to perform operations comprising:
providing an acquire command to the plurality of sensors to instruct the plurality of sensors to send the plurality of measurement values to the management device.

8. The system of claim 1, wherein the receiving of the plurality of measurement values is based on an automatic measurement forwarding.

9. The system of claim 1, the system being configured to perform operations comprising:
executing a machine evaluation utilizing the plurality of measurement values received from the plurality of sensors to determine if an event occurred within the plurality of measurement values.

10. The system of claim 1, the system comprising:
a network supporting communication between the management device and the plurality of sensors.
